(19) United States
(12) Patent Application Publication
(10) Pub. No.: US 2016/0140839 A1
(43) Pub. Date: May 19, 2016

(54) Data/commands through audio channel

(71) Applicant: Mingchih Hsieh, Saratoga, CA (US)

(72) Inventor: Mingchih Hsieh, Saratoga, CA (US)

(21) Appl. No.: 14/191,173

(22) Filed: Feb. 26, 2014

(51) Int. Cl. G08C 23/02; G10L 19/018

(52) U.S. Cl. CPC G08C 23/02; G10L 19/018

(57) ABSTRACT

A method to send data or commands through streaming audio signal by using special tone(s) or waveform at a short period of time or using inaudible tone(s) or waveform, filterable tone(s) or waveform mixed into music or audio signal to send for data/commands. In audio stereo channels, by using one of stereo channels or adaptively arranged by time to use one of channels for sending special tone(s) or waveform for data or command purpose as well switching the speaker of sending command channel to other streaming music or audio channel without creating further noise or interruption.

### FIELD OF THE INVENTION

This invention relates to sending data or commands on streaming audio channel and particular to be insensible interruption of listening using audio channel.

### BACKGROUND

Today, when audio source is streaming the music or audio signal into speaker, the only way to send data or commands is using or adding other protocol on digital channel. For example, Bluetooth uses AVRCP for command and/or SPP for data during A2DP streaming music or audio signal. Those protocol channels won't affect audio signal but create the complex code implementation on protocol handling besides compatibility issues. With simple tone or waveform with some sequence on the same audio channel, the present invention can implement the data or commands with a minimum or unnoticeable interruption with no effort on the protocol channel at all.

### SUMMARY OF THE INVENTION

It is an object of this invention to enable the data and commands capability inside the audio channel without touching the protocol of digital channel. With a short period of time and/or smoothing the tone(s) or waveform, or even by using the one of audio stereo channels, the present invention can achieve in decoding the data and commands and create less or even no interruption with person listening to music or using audio signal.

### BRIEF DESCRIPTION OF THE DRAWINGS

FIG. 1 shows a block diagram of a communication system in accordance with some embodiments of the present disclosure.

FIG. 2 shows a block diagram of a communication system in accordance with some embodiments of the present disclosure.

FIG. 3 shows a time-domain waveform in accordance with some embodiments of the present disclosure.

FIG. 4 shows a frequency-domain spectrum in accordance with some embodiments of the present disclosure.

### DETAILED DESCRIPTION

An audio channel, for example Bluetooth A2DP, only sends music or audio signal, but, however, it cannot send data or command at all. If user wants to send data or commands to receiver side, he or she must use digital protocol, such as AVRCP to send commands or SPP to stream data through. It is not convenient to implement those protocols, besides it may affect the continuity or create the distortion of the original music or audio signal. And also, sometimes, when open up those digital channels, it involves the license issue or cumbersome software coding scheme as well as certification testing.

My invention of sending predictable tones and sequence of controllable time frame to receiving end, or mixing or embedding inaudible tone(s) or waveform inside same audio channel, we can decode those tones by a very easy hardware circuit or DSP code without any protocol intervened.

When using stereo channels, my invention also provides a way to be unnoticeable or insensitive to users or listeners by using one of channels for data or commands usage and during that time frame the speaker can use other channel music or audio signal. Plus turning down or shutting off the path to the channel speaker of data commands or data using, we can make user insensitive to the change of audio signal.

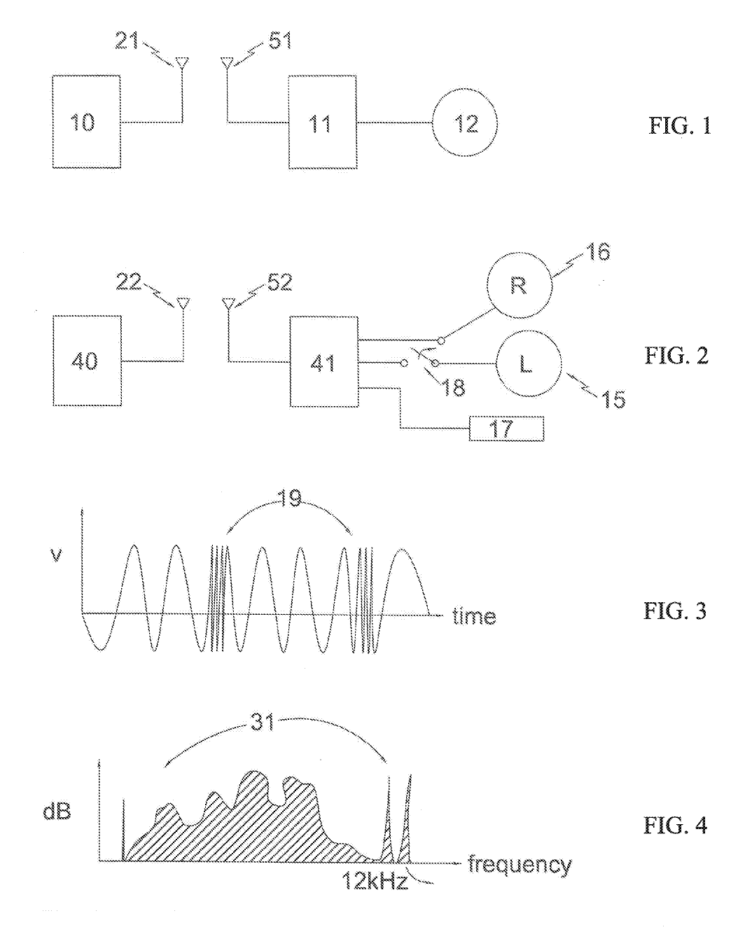

Turning now to a discussion of the drawing, FIG. 1 shows the arrangement of a system for streaming an audio source to an audio sink.

There is shown an audio source 10 which either sending a music or audio signal using the antenna 21 for wireless transmission.

If the receiver 11 receives the music or audio signal from receiving antenna 22 typically, the audio receiving sink circuit will put them into speaker 12 or earphone.

As for data or commands from audio source, prior art uses other protocol of digital channel to send/receive.

The present invention does not need any other extra protocol on digital channel for data or commands.

By using embedded tone or waveform into audio or music streaming simultaneously, or even using, as FIG. 3 an interruption period of time 19 to complete data or commands sending.

Or, even using inaudible tones 31 or waveform as FIG. 4 to mix with music or audio signal to send even possible longer data or commands as well as short ones.

For a stereo channel as FIG. 2, the present embodiment discloses one of channels for temporarily data/command while possibly change streaming speaker 16 by a switch 18 from the other channel, reducing the listening interruption or distortion.

What is claimed is:

1. A system to generate a burst of tone(s) or waveform sequence in order to embed data or commands information inside audio channel wherein we can retrieve data or commands from receiver end with little interruption of normal audio signal streaming.

2. A system according to claim 1, further being configured to send inaudible tone(s) or waveform which increase the possibility of sending longer data or commands to receiving side without interference current music or audio signal for listeners.

3. A system according to claim 1, further being configured to send audible tone(s) or waveform of easily being filtered out at receiver end, or of little degrading original music or audio signal to make listeners unnoticeable.

4. A system to have one of stereo channels using for data or commands purpose and the other still using for audio or music streaming.

5. A system according to claim 4, further being configured to send tone(s) or waveform on one of stereo channels and during that time frame to turn off or reduce volume of original music or audio signal for insensitively listening other channel.

6. A system according to claim 4, further being configured to send tones(s) or waveform on one of stereo channel so that user will not notice from the sending data/command tones(s) or waveform when listing total sound.
